(19) United States
(12) Patent Application Publication
(10) Pub. No.: US 2013/0055070 A1
(43) Pub. Date: Feb. 28, 2013

(54) METHOD OF GENERATING WEB PAGES USING SERVER-SIDE JAVASCRIPT

(71) Applicants: David Oliver SACKS, San Francisco, CA (US); Adam Marc Pisoni, San Francisco, CA (US)

(72) Inventors: David Oliver SACKS, San Francisco, CA (US); Adam Marc Pisoni, San Francisco, CA (US)

(21) Appl. No.: 13/593,462

(22) Filed: Aug. 23, 2012

Related U.S. Application Data
(60) Provisional application No. 61/527,094, filed on Aug. 24, 2011.

(51) Int. Cl. G06F 17/00

(52) U.S. Cl. 715/234

(57) ABSTRACT

A web page including one or more web applications is generated using third-party scripts, in a manner that protects private content that may be included in the web page. According to this technique, third-party scripts that are to be executed within a browser environment are instead executed by a web server that is generating the web page, so that the web server can protect against any programmatic attempts to improperly access private content included in the web page.

### CROSS-REFERENCE TO RELATED APPLICATIONS

This application claims priority benefit to U.S. provisional patent application titled, “METHOD OF GENERATING WEB PAGES USING SERVER-SIDE JAVASCRIPT” filed on Aug. 24, 2011, having application Ser. No. 61/527,094 (Attorney Docket Number YAMR/0006USL), which is incorporated by reference herein.

### BACKGROUND

In recent years, web application programming interfaces (web APIs) that enable software developers to integrate web applications into web pages have become commonplace. One method for developing web applications involves writing JavaScript (JS) code that is executed by a web browser (referred to as “client-side JavaScript”). In some cases, the client-side JS code, when executed by the web browser, interacts with a web API and generates hypertext markup language (HTML) code that is interpreted by the browser and generates a user interface (UI) for the web application with which the user interacts. Typically, the UI for the web application includes information, links and buttons that provide useful features to the user not offered by the web page alone.

Though web applications enhance the overall usability of the web pages through which they are made available, enabling developers to write web applications in JS code poses a serious threat to the privacy of users that operate the web applications. For example, in the case where a user accesses his or her email client and contacts list using a web browser and has opted for his or her email client to include a timezone web application written in JS code that displays to the user a clock for each time zone that he or she has specified, the developer of the timezone web application may conduct malicious activity by configuring the JS code to parse the web page for the “@” symbol to locate all email addresses included in the user's contacts list and then automatically spam those email addresses with links to harmful web pages.

One approach to curing the foregoing client-side JS code security threats involves creating an inline frame (iframe) for each web application that is included in the web page, which effectively sandboxes the web application and prevents it from accessing portions of the web page that lie outside of the iframe. The use of iframes, however, significantly increases the load time and/or memory requirement of web pages, which degrades user satisfaction. Another approach to curing the foregoing client-side JS code security threats involves reviewing all JS code-based web applications submitted by developers to ensure that the JS code is not malicious. This approach, however, is impractical due to the vast number of web applications that have been developed and are being developed. Moreover, the increasing complexity of web applications makes it exceedingly difficult to identify malicious code included in the web application.

### SUMMARY

One or embodiments of the present invention provide a method of generating a web page including one or more web applications using third-party scripts, in a manner that protects private content that may also be included in the web page. According to one or embodiments of the present invention, third-party scripts that are to be executed within a browser environment are instead executed by a web server that is generating the web page so that the web server can protect against any programmatic attempts by the third-party scripts to improperly access private content included in the web page.

A method of generating a web page that includes one or more web applications, according to an embodiment of the present invention, includes the steps of receiving a request to generate the web page, generating hypertext markup language (HTML) code for the web page, wherein the HTML code for the web page includes a different shell area for each of the one or more web applications, generating, for each of the one or more web applications, HTML code for the web application by executing a browser-side script associated with the web application via a server-side script engine, inserting the HTML code for the one or more web applications into respective shell areas included in the web page, and transmitting the web page in response to the request.

Further embodiments of the present invention include, without limitation, a non-transitory computer-readable storage medium and a computer system, each storing instructions to enable a processing unit to implement one or more aspects of the above method.

### BRIEF DESCRIPTION

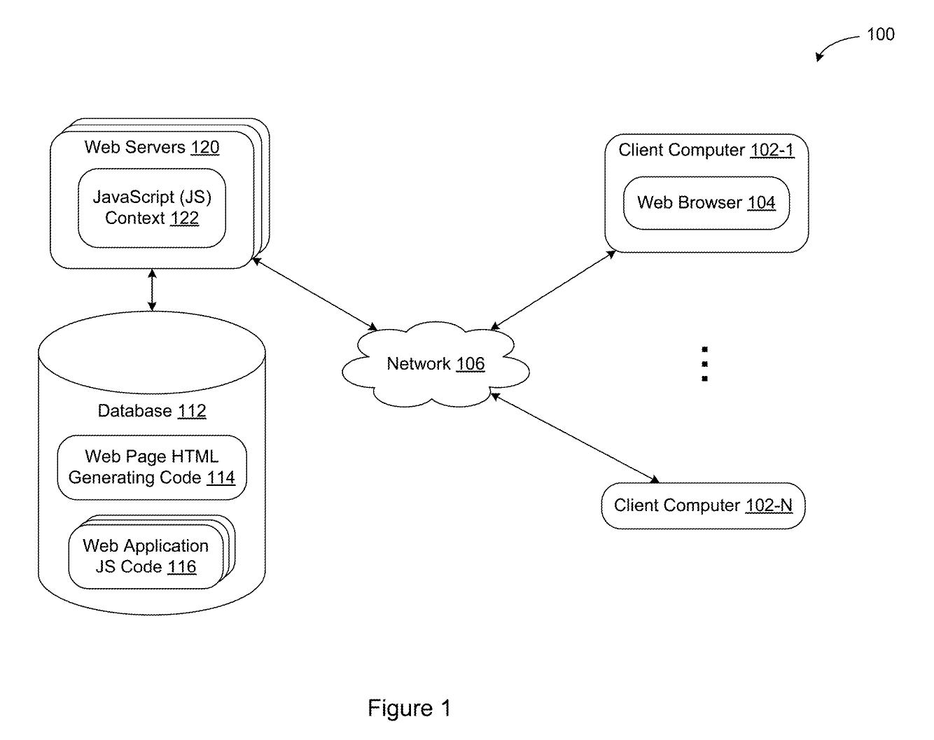

FIG. 1 illustrates a networked computer environment in which embodiments of the invention may be practiced.

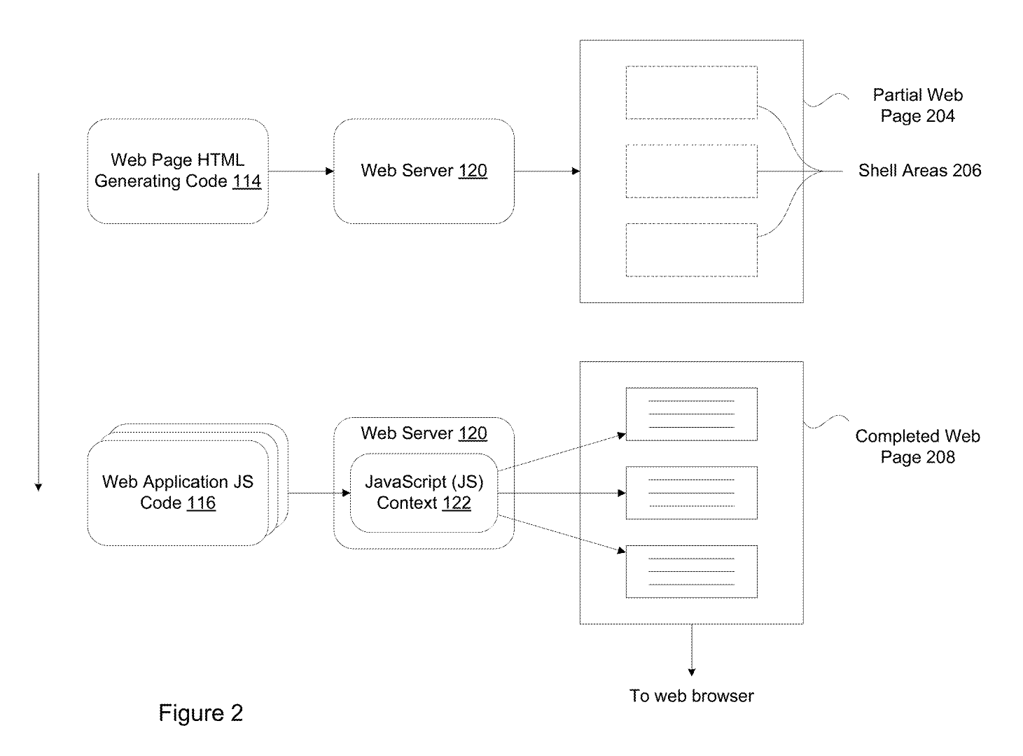

FIG. 2 is a conceptual diagram illustrating the generation of a web page using, at least in part, server-side JavaScript code, according to one or more embodiments of the present invention.

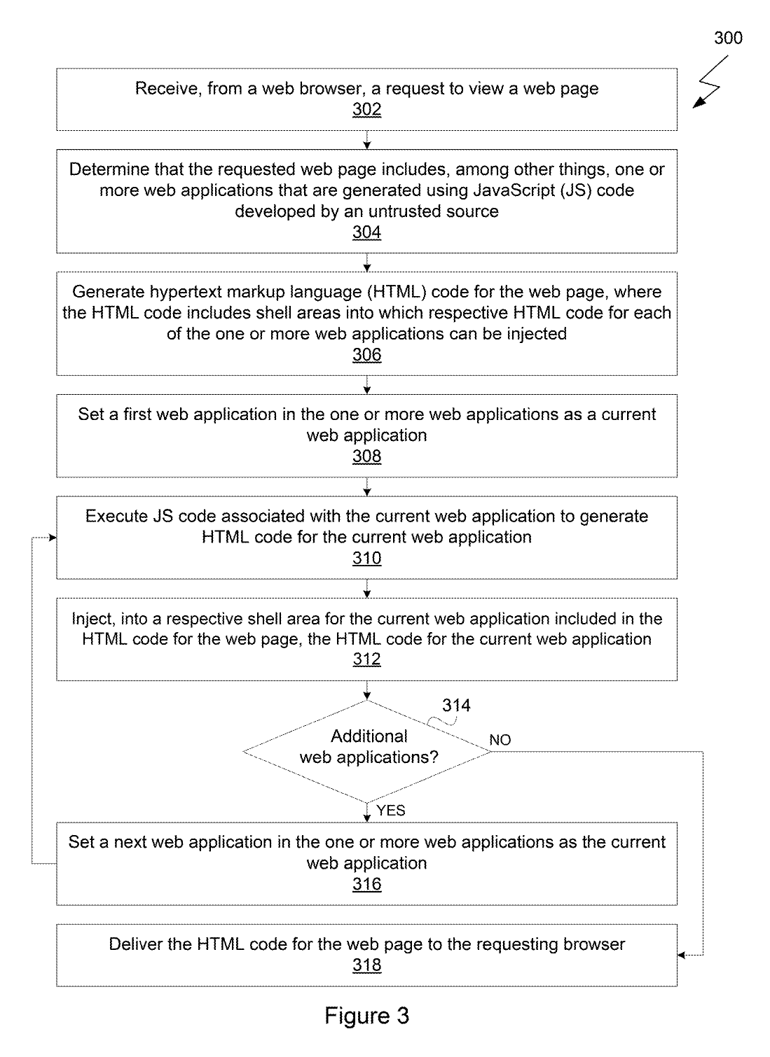

FIG. 3 is a flow diagram of a method of generating a web page using, at least in part, server-side JavaScript code, according to one or more embodiments of the present invention.

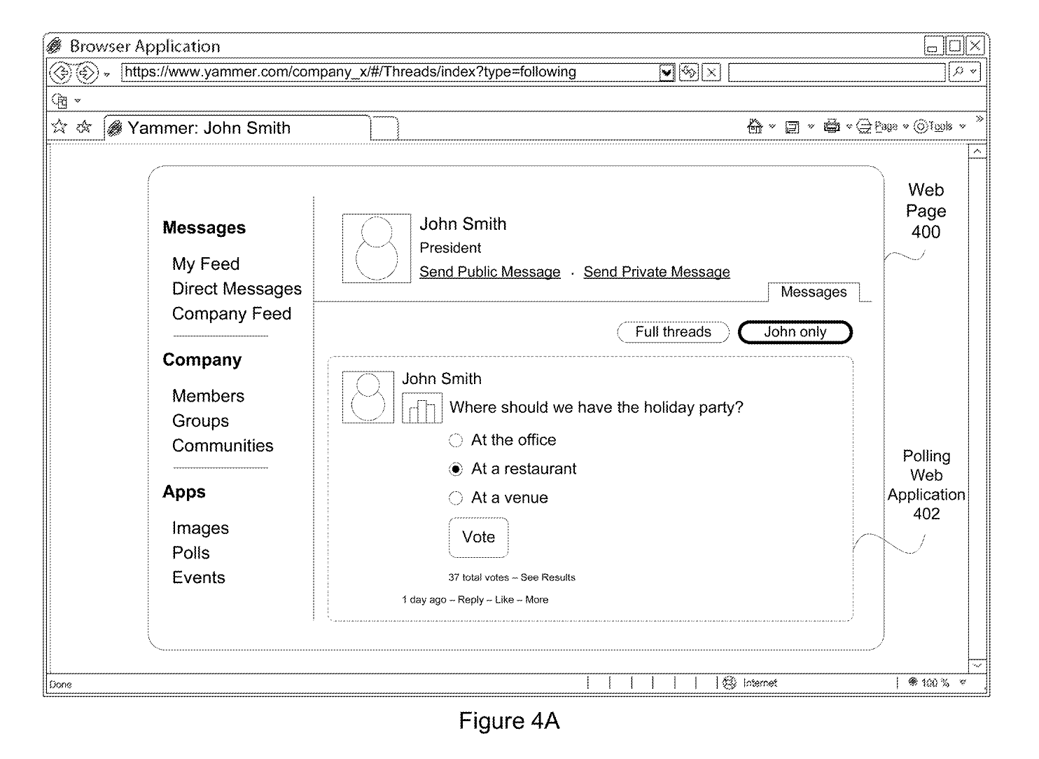

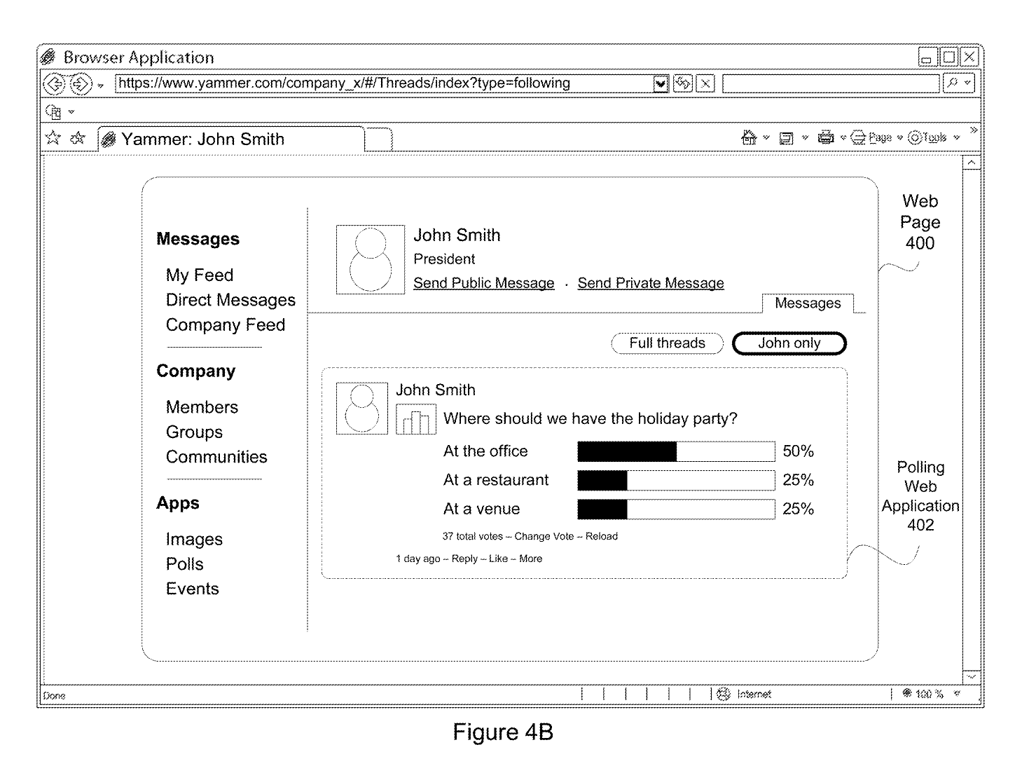

FIGS. 4A-4B are block diagrams illustrating a web page that includes a web application generated using server-side JavaScript code, according to one embodiment of the present invention.

### DETAILED DESCRIPTION

In the following description, several specific details are presented to provide a thorough understanding of embodiments of the invention. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

FIG. 1 illustrates a networked computer environment 100 in which embodiments of the invention may be practiced. As shown, the networked computer environment 100 includes a plurality of client computers 102 (only two of which are shown) and a plurality of web servers 120 that are in communication with database 112, which stores web page HTML generating code 114 and web application JS code 116. Web page HTML generating code 114 refers to code that, when executed, generates HTML code that is specific to, for example, the content of a main web page hosted by web servers 120. Web application JS code 116 refers to code that, when executed by JS context 122, generates HTML code that is specific to, for example, a web application that is integrated within the main web page. Also shown in FIG. 1 is JS context 122, which executes on web server 120 and is configured to emulate a JS engine typically included in all web browsers. As described in further detail herein, JS context 122 is configured to execute web application JS code 116 (referred to herein as “server-side JavaScript code”). In most cases, web application JS code 116 provides additional content that is related to the main web page, e.g., providing to a user of the work collaboration web site Yammer® an easy way to poll his or her co-workers with questions.

Client computers 102 and web servers 120 are connected over a computer network 106, e.g., the Internet. Each client computer 102 includes conventional components of a computing device, e.g., a processor, system memory, a hard disk drive, input devices such as a mouse and a keyboard, and output devices such as a monitor (not shown). Each web server 120 includes a processor and a system memory (not shown), and manages content stored in database 112 using, e.g., a relational database software. Web servers 120 are programmed to communicate with one another and are also programmed to communicate with client computers 102 using, e.g., the TCP/IP protocol. Client computers 102 are programmed to execute web browser 104, which accesses the web pages and/or applications managed by web servers 120 by, for example, specifying in web browser 104 a uniform resource locator (URL) that directs to web servers 120.

In the embodiments of the present invention described below, users are respectively operating client computers 102 that are connected to web servers 120 over network 106. The web pages that are displayed to a user are transmitted from the web servers 120 to the user's client computer 102 and processed by the web browser program 104 stored in that user's client computer 102 for display through a display device in communication with that user's client computer 102.

FIG. 2 is a conceptual diagram illustrating the generation of a web page using, at least in part, server-side JavaScript, according to one or more embodiments of the present invention. In the example illustrated in FIG. 2, web server 120 receives from web browser 104 being operated by a user a request to generate a web page. The request is delivered to web server 120 via a URL address that directs the request to web server 120, e.g., “www.Yammer.com”. Such a request is often accompanied by parameters that enable web server 120 to respond to the request with the appropriate web page, such as login credentials of the user.

In the foregoing example, it is assumed that the web page includes both native content generated by www.Yammer.com, e.g., private data associated with the user, and foreign content generated by web applications compatible with www.Yammer.com and configured to be part of the web page, e.g., a weather web application, a news feed web application, and a daily task list web application.

As shown in FIG. 2, web server 120 retrieves, in response to the request, web page HTML generating code 114 from database 112 and executes web page HTML generating code 114 to generate HTML code for the web page requested by the user. Here, web page HTML generating code 114 is code developed by www.Yammer.com and is configured to generate the native content described above. Web page HTML generating code 114 may be implemented using any coding technology that enables the generation of HTML code, such as Active Server Page (ASP) technology by Microsoft®. Web server 120 executes web page HTML generating code 114 and generates a partial web page 204 (i.e., the native content of the web page). As shown, partial web page 204 includes, for each of the three aforementioned web applications that are included in the web page, a shell area 206 that provides an area into which HTML code generated by a different one of the web applications (i.e., the foreign content of the web page) is inserted.

Subsequent to generating partial web page 204, web server 120 loads and executes web application JS code 116 to generate the foreign content that is inserted into shell areas 206. For example, web server 120 loads web application JS code 116 for each of the weather web application, the news feed web application, and the daily task list web application, and executes the JS code 116 to generate the foreign content.

To prevent web application JS code 116 from being capable of conducting malicious activity, web application JS code 116 is expressly prohibited by JS context 122 from accessing partial web page 204 which, as described above, may include sensitive content. More specifically, web application JS code 116 has no visibility to any HTML code other than the HTML code that web application JS code 116 generates. In this way, if web application JS code 116 is malicious and attempts to access partial web page 204, the attempt immediately fails, and the sensitive native content included in partial web page 204 is prevented from being accessed. Moreover, the foregoing technique prevents web application JS code 116 of a particular web application from accessing HTML code generated by different web applications, which further ensures that the user's privacy remains intact.

When each of shell areas 206 are filled with foreign HTML code generated by web application JS code 116, partial web page 204 transitions into completed web page 208, which comprises HTML code that is delivered to a web browser. Web browser 104 receives and interprets the HTML code included in completed web page 208 and renders the web page requested by the user, which includes both the native content generated by www.Yammer.com and the foreign content generated by the web applications included in the web page.

FIG. 3 is a flow diagram of a method 300 of generating a web page using, at least in part, server-side JavaScript code, according to one or more embodiments of the present invention. As shown, method 300 begins at step 302, where web server 120 receives, from web browser 104, a request to view a web page. At step 304, web server 120 determines that the requested web page includes, among other things, one or more web applications that are generated using JS code developed by an untrusted source.

At step 306, web server 120 generates HTML code for the web page, where the HTML code includes shell areas into which respective HTML code for each of the one or more web applications can be injected, as described above in conjunction with FIG. 2.

At step 308, web server 120 sets a web application in the one or more web applications as a current web application. At step 310, web server 120 executes, by operation of JS context 122, JS code associated with the current web application to generate HTML code for the current web application. At step 312, web server 120 injects, into the respective shell area for the current web application included in the HTML code for the web page, the HTML code for the current web application.

At step 314, web server 120 determines whether the web page includes additional web applications. If, at step 314, web server 120 determines that additional web applications are included in the web page, then at step 316, web server 120 sets a next web application in the one or more web applications as the current web application. Method steps 310-316 are repeated until HTML code for each of the one or more web applications has been generated and injected into the respective shell area.

At step 318, web server 120 delivers the HTML code for the web page to the requesting browser. Thus, method 300 provides a technique where execution of the JS code for each of the web applications is completely isolated, which prevents malicious activity intended by any of the web applications from successfully executing.

FIGS. 4A-4B are block diagrams illustrating a web page 400 that includes a polling web application 402 generated using server-side JavaScript code, according to one embodiment of the present invention. As shown in FIG. 4A, web page 400 is associated with a “feed” interface provided by Yammer®, which includes a polling web application 402. Here, polling web application 402 is a web application developed by a third party (i.e., an untrusted source) and enables Yammer users to poll their co-workers with questions to which two or more answers may be provided. In view of the techniques described above in conjunction with FIGS. 2-3, the content that surrounds polling web application 402 is native content generated by Yammer, while the content within polling web application 402 is foreign content generated by the third party web application developer.

As shown in FIG. 4B, the foreign content of polling web application 402 is updated when, e.g., a user submits his or her vote by selecting a radio button associated with an answer to the poll and clicking the “Vote” button with his or her mouse. When an update to polling web application 402 is triggered, web server 120 regenerates web page 400 according to the techniques described above in conjunction with FIGS. 2-3. In this way, the JS code associated with polling web application 402 is re-executed by JS context 122 according to the vote placed by the user, and results associated with the poll are displayed to the user in web page 400. In some embodiments, only updated HTML code for the web application is delivered to the web browser to replace the HTML code included in the respective shell area, which saves bandwidth and processing time. As a result, polling web application 402 never able to gain access to any of the native content included in web page 400—nor to any of the foreign content generated by different web applications included in web page 400—thereby maintaining that the privacy of the user is protected.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

What is claimed is:

1. A method of generating a web page that includes one or more web applications, comprising the steps of:
receiving a request to generate the web page;
generating hypertext markup language (HTML) code for the web page, wherein the HTML code for the web page includes a different shell area for each of the web applications;
generating, for each of the web applications, HTML code for the web application by executing a browser-side script associated with the web application via a server-side script engine;
inserting the HTML code for the one or more web applications into respective shell areas included in the web page; and
transmitting the web page in response to the request.

2. The method of claim 1, further comprising the steps of:
receiving a request from the user to update a view of one of the web applications;
generating updated HTML code for the web application by re-executing the browser-side script based on the request via a server-side script engine; and
transmitting the updated HTML code in response to the request.

3. The method of claim 2, wherein HTML code for other portions of the web page are not transmitted with the updated HTML code.

4. The method of claim 1, wherein the browser-side script associated with each of the web applications is stored in a database that is not accessible to the web browser application but is accessible to the server-side script engine.

5. The method of claim 1, wherein the request is received from a web browser application and the web page is transmitted to the web browser application.

6. The method of claim 1, wherein the browser-side script is JavaScript (JS) code and the server-side script engine is a server-side JS engine.

7. The method of claim 1, wherein at least one of the web applications is developed from an untrusted source.

8. A non-transitory computer readable storage medium comprising instructions for causing a computer system for carrying out a method of generating a web page that includes one or more web applications, said method comprising the steps of:
receiving a request to generate the web page;
generating hypertext markup language (HTML) code for the web page, wherein the HTML code for the web page includes a different shell area for each of the web applications;
generating, for each of the web applications, HTML code for the web application by executing a browser-side script associated with the web application via a server-side script engine;
inserting the HTML code for the one or more web applications into respective shell areas included in the web page; and
transmitting the web page in response to the request.

9. The non-transitory computer readable storage medium of claim 8, wherein the method further comprises the steps of:
receiving a request from the user to update a view of one of the web applications;
generating updated HTML code for the web application by re-executing the browser-side script based on the request via a server-side script engine; and
transmitting the updated HTML code in response to the request.

10. The non-transitory computer readable storage medium of claim 9, wherein HTML code for other portions of the web page are not transmitted with the updated HTML code.

11. The non-transitory computer readable storage medium of claim 8, wherein the browser-side script associated with each of the web applications is stored in a database that is not accessible to the web browser application but is accessible to the server-side script engine.

12. The non-transitory computer readable storage medium of claim 8, wherein the request is received from a web browser application and the web page is transmitted to the web browser application.

13. The non-transitory computer readable storage medium of claim 8, wherein the browser-side script is JavaScript (JS) code and the server-side script engine is a server-side JS engine.

14. The non-transitory computer readable storage medium of claim 8, wherein at least one of the web applications is developed by an untrusted source.

15. A computer system for an online network of users, comprising:
a database of users including private content of the users; and
a web server for generating a web page that includes private content of a user and a web application from an untrusted source, the web server having a server-side script engine for executing a browser-side script associated with the web application and generating HTML code for the web application with the server-side script engine.

16. The computer system of claim 15, wherein the web server is configured to generate HTML code for a web page that includes a shell area for the web application and insert the HTML code for the web application into the shell area.

17. The computer system of claim 16, wherein web page including the web application is transmitted to a web browser application.

18. The computer system of claim 17, wherein the web server is configured to re-execute the browser-side script to generate an updated HTML code for the web application, and transmit the updated HTML code to the web browser application.

19. The computer system of claim 18, wherein HTML code for other portions of the web page are not transmitted with the updated HTML code.

20. The computer system of claim 15, wherein the browser-side script is JavaScript (JS) code and the server-side script engine is a server-side JS engine.
